(19) United States
(12) Patent Application Publication
(10) Pub. No.: US 2013/0148012 A1
(43) Pub. Date: Jun. 13, 2013

(54) IMAGING LENS AND IMAGING APPARATUS

(71) Applicant: Sony Corporation, Tokyo (JP)

(72) Inventors: Takayuki Yamazaki, Aichi (JP); Hideaki Okano, Aichi (JP)

(73) Assignee: Sony Corporation, Tokyo (JP)

(21) Appl. No.: 13/687,455

(22) Filed: Nov. 28, 2012

(30) Foreign Application Priority Data
Dec. 13, 2011 (JP) 2011-272381

(51) Int. Cl. H04N 5/225; G02B 9/34

(52) U.S. Cl. CPC H04N 5/2254; G02B 9/34
USPC 348/360; 359/773

(57) ABSTRACT

An imaging lens, including in order from an object side to an image side, an aperture stop, a first lens formed in a biconvex shape having a positive refractive power, a second lens having a negative refractive power with a surface on the image side formed to be a concave surface, a third lens having a positive refractive power with a convex surface faced to the image side, and a fourth lens having a negative refractive power with a surface on the image side formed to be a concave surface.

### BACKGROUND

The present technology relates to an imaging lens and an imaging apparatus. In particular, the present technology relates to a technical field of an imaging lens suited for a compact imaging apparatus using a high-pixel density solid-state imaging element, and an imaging apparatus having the imaging lens.

Image apparatuses such as camera-equipped mobile phones and digital still cameras using charge-coupled devices (CCDs) and complementary metal-oxide semiconductors (CMOSs), for example, as solid-state image elements, have heretofore been known.

In recent years, there has been an increasing demand for size reduction in such imaging apparatuses, and an imaging lens to be mounted has been also demanded to reduce the size by reducing a total optical length. An imaging apparatus having such a compact imaging lens exists from the past (for example, see Japanese Patent Application Laid-Open No. 2005-292559).

Meanwhile, in recent years, in small-sized imaging apparatuses such as camera-equipped mobile phones, a pixel density of an imaging element has become particularly higher. For example, the imaging apparatuses in which a high-pixel density imaging element of a so-called mega-pixel or more having resolutions of one million pixels or more is mounted have been popular.

Therefore, the imaging lens to be mounted is demanded to have high lens performance corresponding to the aforementioned high-pixel density imaging element. An imaging apparatus using an imaging lens having the high lens performance exists from the past (for example, see Japanese Patent Application Laid-Open No. 2002-365531).

### SUMMARY

The imaging lens described in Japanese Patent Application Laid-Open No. 2005-292559 has a fourth lens formed in a meniscus shape with a convex surface faced to an object side, so that a peripheral portion of the fourth lens is greatly projected toward an image surface.

Therefore, it is necessary to make a back focus longer to avoid bringing in contact with an optical low-pass filter, an infrared cut filter, a sealing glass of a solid-state imaging element package, or the like disposed between the fourth lens and the imaging element, so that the overall size is increased to ensure the back focus. Accordingly, it is hard to say that a sufficient size reduction is realized.

Meanwhile, the imaging lens described in Japanese Patent Application Laid-Open No. 2002-365531 includes, in order from an object side to an image side, an aperture stop, a first lens formed in a biconvex shape having a positive refractive power, a second lens having a negative refractive power, a third lens having a positive refractive power with a convex surface faced to the image side, and a fourth lens having a negative refractive power.

According to such a lens arrangement, although a surface on the object side of the fourth lens is designed as a convex surface, it may be difficult to distribute compensation of coma aberration for the entire imaging lens due to an action of the convex surface, and compensation of aberration to satisfy optical performance as the entire imaging lens may be insufficient.

Therefore, in the imaging lens and the imaging apparatus according to embodiments of the present technology, it is desirable to overcome the above problems and improve optical characteristics while ensuring the size reduction.

First, according to an embodiment of the present technology, there is provided an imaging lens including: in order from an object side to an image side, an aperture stop; a first lens formed in a biconvex shape having a positive refractive power; a second lens having a negative refractive power and a surface on the image side formed to be a concave surface; a third lens formed in a meniscus shape having a positive refractive power with a convex surface faced to the image side; and a fourth lens having a negative refractive power and a surface on the image side formed to be a concave surface, the imaging lens satisfying the following conditional expressions (1) to (5),

0≦(R2+R1)/(R2−R1)≦1 (1)

R3≦0 (2)

0.1<D34/f<0.3 (3)

−8≦(R6+R5)/(R6−R5)≦−2 (4)

R7≦0 (5)

where
R1: a radius of curvature of a surface on the object side in the first lens,
R2: a radius of curvature of a surface on the image side in the first lens,
R3: a radius of curvature of a surface on the object side in the second lens,
f: a focal length of an entire lens system,
D34: an air interval between the third lens and the fourth lens,
R5: a radius of curvature of a surface on the object side in the third lens,
R6: a radius of curvature of a surface on the image side in the third lens, and
R7: a radius of curvature of a surface on the object side in the fourth lens.

Therefore, in the imaging lens, an entrance pupil position can be set at a position distant from the image surface and various aberrations are suitably compensated.

Second, in the imaging lens described above, it is suitable that the following conditional expression (6) is satisfied,

0<D34−D23 (6)

where
D23: an air interval between the second lens and the third lens, and
D34: an air interval between the third lens and the fourth lens.

The imaging lens satisfies the conditional expression (6), so that the negative refractive power of a symmetrical system formed by the surface on the image side in the second lens and the surface on the object side in the third lens is well-balanced and a good telephoto ratio is ensured.

Third, in the imaging lens described above, it is suitable that refractive indexes and Abbe numbers of the first lens, the third lens, and the fourth lens are the same.

Since the refractive indexes and the Abbe numbers of the first lens, the third lens, and the fourth lens are the same, a variation of the optical performance due to a lot difference of materials is minimized.

Fourth, in the imaging lens described above, it is suitable that the refractive index of the second lens is larger than that of the first lens, the third lens, and the fourth lens.

Since the refractive index of the second lens is larger than that of the first lens, the third lens, and the fourth lens, chromatic aberration is compensated by the second lens.

According to another embodiment of the present technology, there is provided an imaging apparatus including: an imaging lens; and an imaging element configured to convert an optical image formed by the imaging lens into an electric signal; in which the imaging lens has, in order from an object side to an image side, an aperture stop, a first lens formed in a biconvex shape having a positive refractive power, a second lens having a negative refractive power and a surface on the image side formed to be a concave surface, a third lens formed in a meniscus shape having a positive refractive power with a convex surface faced to the image side, and a fourth lens having a negative refractive power and a surface on the image side formed to be a concave surface, the imaging lens satisfying the following conditional expressions (1) to (5),

0≦(R2+R1)/(R2−R1)≦1 (1)

R3≦0 (2)

0.1<D34/f<0.3 (3)

−8≦(R6+R5)/(R6−R5)≦−2 (4)

R7≦0 (5)

where
R1: a radius of curvature of a surface on the object side in the first lens,
R2: a radius of curvature of a surface on the image side in the first lens,
R3: a radius of curvature of a surface on the object side in the second lens,
f: a focal length of an entire lens system,
D34: an air interval between the third lens and the fourth lens,
R5: a radius of curvature of a surface on the object side in the third lens,
R6: a radius of curvature of a surface on the image side in the third lens, and
R7: a radius of curvature of a surface on the object side in the fourth lens.

Therefore, in the imaging apparatus, an entrance pupil position can be set at a position distant from the image surface and various aberrations are suitably compensated.

The imaging lens and the imaging apparatus according to the embodiments of the present technology can improve the optical characteristics while ensuring the size reduction.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing a lens configuration of a first embodiment of an imaging lens;

FIG. 2 is a diagram showing spherical aberration, astigmatism, and distortion of a numerical example in which specific numeral values are applied to the first embodiment;

FIG. 3 is a diagram showing a lens configuration of a second embodiment of the imaging lens;

FIG. 4 is a diagram showing spherical aberration, astigmatism, and distortion of a numerical example in which specific numeral values are applied to the second embodiment;

FIG. 5 a diagram showing a lens configuration of a third embodiment of the imaging lens;

FIG. 6 is a diagram showing spherical aberration, astigmatism, and distortion of a numerical example in which specific numeral values are applied to the third embodiment;

FIG. 7 a diagram showing a lens configuration of a fourth embodiment of the imaging lens;

FIG. 8 is a diagram showing spherical aberration, astigmatism, and distortion of a numerical example in which specific numeral values are applied to the fourth embodiment;

FIG. 9 a diagram showing a lens configuration of a fifth embodiment of the imaging lens;

FIG. 10 is a diagram showing spherical aberration, astigmatism, and distortion of a numerical example in which specific numeral values are applied to the fifth embodiment;

FIG. 11 is a diagram showing a lens configuration of a sixth embodiment of the imaging lens;

FIG. 12 is a diagram showing spherical aberration, astigmatism, and distortion of a numerical example in which specific numeral values are applied to the sixth embodiment;

FIG. 13 shows, together with FIG. 14, a perspective view of a mobile phone to which the imaging apparatus according to an embodiment of the present technology is applied; and

FIG. 14 is a block diagram.

### DETAILED DESCRIPTION OF EMBODIMENTS

Hereinafter, suitable embodiments for carrying out an imaging lens and an imaging apparatus according to embodiments of the present technology will be described.

### [Configuration of Imaging Lens]

The imaging lens according to an embodiment of the present technology includes, in order from an object side to an image side, an aperture stop, a first lens formed in a biconvex shape having a positive refractive power, a second lens having a negative refractive power and a surface on the image side formed on a concave surface, a third lens formed in a meniscus shape having a positive refractive power with a convex surface faced to the image side, and a fourth lens having a negative refractive power and a surface on the image side formed on a concave surface.

In the imaging lens according to the embodiment of the present technology, the aperture stop is disposed to the object side than the first lens, so that an entrance pupil position can be set at a position distant from the image surface and high telecentricity can be ensured, which makes it possible to optimize an incident angle to the image surface.

In the imaging lens according to the embodiment of the present technology, the following conditional expressions (1) to (5) are satisfied,

0≦(R2+R1)/(R2−R1)≦1 (1)

R3≦0 (2)

0.1<D34/f<0.3 (3)

−8≦(R6+R5)/(R6−R5)≦−2 (4)

R7≦0 (5)

where
R1: a radius of curvature of a surface on the object side in the first lens,
R2: a radius of curvature of a surface on the image side in the first lens,
R3: a radius of curvature of a surface on the object side in the second lens,
f: a focal length of an entire lens system,
D34: an air interval between the third lens and the fourth lens,
R5: a radius of curvature of a surface on the object side in the third lens,
R6: a radius of curvature of a surface on the image side in the third lens, and
R7: a radius of curvature of a surface on the object side in the fourth lens.

The conditional expression (1) is an expression for defining a relationship between radius of curvature of the surface on the object side and the surface on the image side of the first lens and for limiting the shape of the first lens.

The shape of the first lens produces a significant effect on the aberration compensation of the entire imaging lens. Specifically, unless a shape balance is set so as to be a minimum angle of deviation with respect to on-axial peripheral rays in the first lens, it is difficult to compensate spherical aberration. When the balance is set to exceed the conditional expression (1), it is necessary to make the refractive power of the second lens larger than necessary, thereby causing significant coma aberration and astigmatism which are off-axis aberration in the second lens.

As a result, when the value of the conditional expression (1) exceeds a specified range, it is difficult to suppress a generation of high order aberrations and specifically it may be difficult to compensate the spherical aberration.

Therefore, the imaging lens satisfies the conditional expression (1), which eliminates the necessity to make the refractive power of the second lens larger than necessary and suppresses the generation of the coma aberration and the astigmatism which are the off-axis aberration in the second lens, and it is possible to suppress a generation of high order aberrations and specifically compensate spherical aberration suitably.

It should be noted that in the imaging lens according to the embodiment of the present technology, in order to improve the optical performance by further suppressing the generation of the spherical aberration and the like, it is more suitable that the conditional expression (1) is set to (1)′ 0.1≦(R2+R1)/(R2−R1)≦0.8.

Moreover, in the imaging lens according to the embodiment of the present technology, in order to further improve the optical performance by further suppressing the generation of the spherical aberration and the like, it is more suitable that the conditional expression (1) is set to (1)″ 0.229≦(R2+R1)/(R2−R1)≦0.648.

The conditional expression (2) is an expression for defining a radius of curvature of the surface on the object side of the second lens.

In the imaging lens according to the embodiment of the present technology, the second lens has a smaller Abbe number than other lenses.

Therefore, when the negative refractive power of the surface on the object side in the second lens is weakened beyond a specified range by exceeding the range of the conditional expression (2), the refractive power with respect to an F-line and a g-line becomes weak and axial chromatic aberration is likely to occur.

Moreover, although the refractive power can be shared on the surface on the image side in the second lens by bending, it is not easy to compensate the aberration in comparison with a case where a divergent function of the second lens is attempted to be provided to the both surfaces.

Therefore, the imaging lens satisfies the conditional expression (2), so that the generation of the axial chromatic aberration can be suppressed.

It should be noted that in the imaging lens according to the embodiment of the present technology, in order to further improve the optical performance by further suppressing the generation of the axial chromatic aberration, it is more suitable that the conditional expression (2) is set to (2)′ −1000≦R3≦−4.0.

The conditional expression (3) is an expression for defining a relationship between the focal length f of the entire lens system and the air interval between the third lens and the fourth lens.

In the imaging lens according to the embodiment of the present technology, in order to reduce the size, the refractive power of a lens is distributed to positive, negative, positive, and negative powers in order from the object side to the image side, and the air interval between the third lens and the fourth lens is further widen as much as possible, thereby realizing a so-called telephoto type.

Moreover, since the refractive power of the fourth lens can be reduced by widening the air interval between the third lens and the fourth lens as much as possible, it is advantageous to compensate the entire aberration.

However, when the value of the air interval expressed by the conditional expression (3) exceeds the specified range, it is difficult to ensure suitable thicknesses of the centers of the lenses from the first lens to the fourth lens by reducing the overall length, and manufacturing difficulty increases.

Therefore, the imaging lens satisfies the conditional expression (3), so that it is possible to compensate the entire aberration suitably and decrease the manufacturing difficulty.

It should be noted that in the imaging lens according to the embodiment of the present technology, in order to ensure a good optical performance and suitable thicknesses of the centers of the lenses, it is more suitable that the conditional expression (3) is set to (3)′ 0.12<D34/f<0.26.

The conditional expression (4) is an expression for defining a relationship between radius of curvature of the surface on the object side and the surface on the image side of the third lens and for limiting the shape of the third lens.

In the imaging lens according to the embodiment of the present technology, by forming the surface on the object side in the third lens to be a concave surface, it is possible to form a diverging surface which is a symmetrical system in a lens system together with the concave surface on the image side surface in the second lens. As a typical lens configuration of the symmetrical system, a Gauss type is known. By forming a lens surface (diverging surface) of the symmetrical system, the upper and lower rays can be compensated, and the spherical aberration, the coma aberration, and field curvature can be compensated well.

As a result, when the value of the conditional expression (4) exceeds a specified range, it is difficult to suppress a generation of high order aberrations and specifically it may be difficult to compensate the spherical aberration and the coma aberration.

Therefore, the imaging lens satisfies the conditional expression (4), so that the generation of high order aberrations is suppressed and the spherical aberration and the coma aberration can be compensated well.

The conditional expression (5) is an expression for defining a radius of curvature of the surface on the object side of the fourth lens.

In the imaging lens according to the embodiment of the present technology, by forming the surface on the object side in the fourth lens to be a concave surface, an incident angle of principal ray can be made nearly vertical in a viewing angle from an on-axis to a most peripheral image height. The way of the ray passage can avoid refraction of the ray more than necessary and distortion can be compensated.

Moreover, the effect of the concave surface is specifically beneficial to the ray in a sagittal direction, and sagittal coma flare which tends to occur at a wide viewing angle can be suppressed.

As a result, when the value of the conditional expression (5) exceeds a specified range, an angle at which peripheral ray is incident on the surface on the object side becomes large and it is difficult to compensate the distortion and the sagittal coma.

Therefore, the imaging lens satisfies the conditional expression (5), so that the refraction of the ray more than necessary can be avoided, the distortion can be compensated, which is beneficial to the ray in a sagittal direction, and the sagittal coma can be compensated well.

It should be noted that in the imaging lens according to the embodiment of the present technology, in order to improve the optical performance by further compensating the aberration, it is more suitable that the conditional expression (5) is set to (5)′ −65≦R7≦−2.

As described above, the imaging lens according to the embodiment of the present technology includes, in order from the object side to the image side, the aperture stop, the first lens formed in a biconvex shape having a positive refractive power, the second lens having a negative refractive power and the surface on the image side formed to be the concave surface, the third lens formed in a meniscus shape having a positive refractive power with the convex surface faced to the image side, and the fourth lens having a negative refractive power and the surface on the image side formed to be the concave surface, the imaging lens satisfying the conditional expressions (1) to (5).

Therefore, since the entrance pupil position can be set at a position distant from the image surface, the incident angle to the image surface is optimized and a compact imaging lens having various aberrations suitably compensated and good optical characteristics can be obtained.

According to the embodiment of the present technology, it is suitable that the imaging lens satisfies the following conditional expression (6):

0<D34−D23 (6)

where
D23: an air interval between the second lens and the third lens, and
D34: an air interval between the third lens and the fourth lens.

The conditional expression (6) is an expression for defining a balance of the air interval between the second lens and the third lens and the air interval between the third lens and the fourth lens.

When the range of the conditional expression (6) is exceeded, a balance of the negative refractive power of a symmetrical system formed by the surface on the image side in the second lens and the surface on the object side in the third lens is lost, it is difficult to compensate the spherical aberration and the coma aberration, and the space between the third lens and the fourth lens is decreased, which deviates the telephoto ratio and makes it difficult to reduce in size of the entire optical system.

Therefore, the imaging lens satisfies the conditional expression (6), so that it is possible to reduce a total optical length and improve the optical performance.

It should be noted that in the imaging lens according to the embodiment of the present technology, in order to ensure a good refractive power balance and reduce a total optical length, it is more suitable that the conditional expression (6) is set to (6)′ 0<D34−D23<0.65.

In the imaging lens according to the embodiment of the present technology, it is suitable that the refractive indexes and the Abbe numbers of the first lens, the third lens, and the fourth lens are the same.

The first lens, the third lens, and the fourth lens are formed by the same material and the refractive indexes and the Abbe numbers are the same, so that the manufacturing cost can be reduced and a variation of the optical performance due to a lot difference of materials can be minimized.

In the imaging lens according to the embodiment of the present technology, it is suitable that the refractive index of the second lens is larger than that of the first lens, the third lens, and the fourth lens.

Since the refractive index of the second lens is larger than that of the first lens, the third lens, and the fourth lens, the chromatic aberration can be suitably compensated by the second lens.

### [Numerical Example of Imaging Lens]

Hereinafter, specific embodiments of the imaging lens according to the embodiment of the present technology and numerical examples in which specific numeral values are applied to the respective embodiments will be described with reference to the accompanying drawings and tables.

It should be noted that meanings or the like of symbols which will be shown hereinafter in tables and the descriptions are as follows.

“Si” represents a surface number of the i-th surface counted from the object side to the image side, “Ri” represents a paraxial radius of curvature of the i-th surface, “Di” represents an axial surface interval between the i-th surface and the i+1-th surface (a lens central thickness or an air interval), “Ni” represents a refractive index in a d-line (λ=587.6 nm) of a lens or the like beginning with the i-th surface, and “νi” represents an Abbe's number in the d-line of the lens or the like beginning with the i-th surface.

With regard to “Si,” “ASP” represents that the surface is an aspherical surface. With regard to “Ri,” “∞” represents that the surface is a flat surface.

“κ” represents a conic constant, and “A3” to “A16” represent 3-order to 16-order aspherical surface coefficients, respectively.

“Fno” represents an F-number, “f” represents a focal length, and “ω” represents a half viewing angle.

Some imaging lenses used in the embodiments have aspherical lens surfaces. The aspherical surface shape is defined by the following expression 1:

$$x = \frac{{cy}^{2}}{1 + \sqrt{1 - ( 1 + κ ) {c}^{2} {y}^{2}}} + Σ {A}_{i} \cdot {y}^{′}$$

where “x” is a distance in an optical axis direction from the apex of the lens surface (sag amount), “y” is a height in a direction perpendicular to the optical axis direction (image height), “c” is a paraxial radius of curvature in the lens apex (reciprocal of curvature radius), “κ” is a conic constant, and “Ai” is an i-th order aspherical coefficient.

It should be noted that in each drawing showing the configuration of the imaging lens, “AX” represents an optical axis.

### First Embodiment

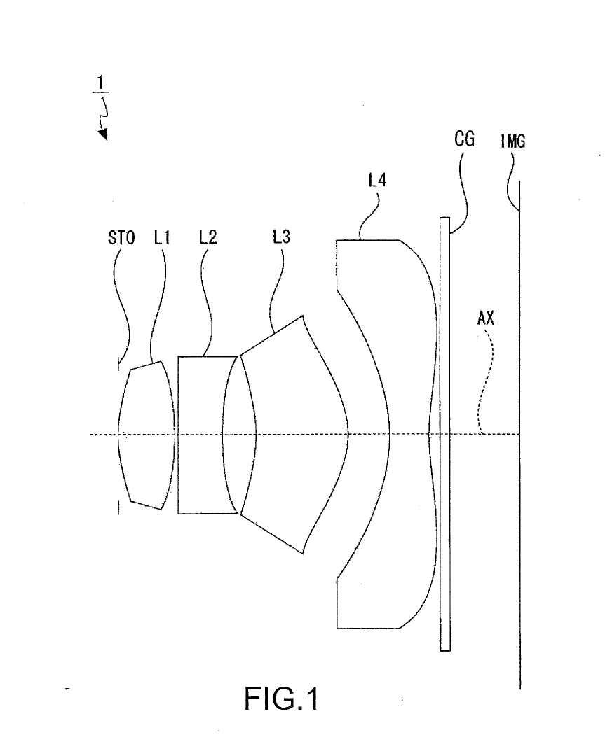

FIG. 1 shows a lens configuration of an imaging lens 1 according to a first embodiment of the present technology.

The imaging lens 1 includes, in order from an object side to an image side, an aperture stop STO, a first lens L1 formed in a biconvex shape having a positive refractive power, a second lens L2 formed in a biconcave shape having a negative refractive power, a third lens L3 formed in a meniscus shape having a positive refractive power with a convex surface faced to the image side, and a fourth lens L4 formed in a biconcave shape having a negative refractive power.

The aperture stop STO, the first lens L1, the second lens L2, the third lens L3, and the fourth lens L4 are disposed and fixed.

A cover glass CG is disposed between the fourth lens L4 and an image surface IMG.

Table 1 shows lens data of a numerical example 1 in which specific numeral values are applied to the imaging lens 1 according to the first embodiment.

TABLE 1

| Si | Ri | Di | Ni | νi |
|---|---|---|---|---|
| Stop | ∞ | 0 | | |
| 1 (ASP) | 1.687 | 0.645 | 1.532 | 55.800 |
| 2 (ASP) | −2.691 | 0.025 | | |
| 3 (ASP) | −5.717 | 0.500 | 1.642 | 23.891 |
| 4 (ASP) | 4.287 | 0.381 | | |
| 5 (ASP) | −2.399 | 1.056 | 1.532 | 55.800 |
| 6 (ASP) | −1.151 | 0.466 | | |
| 7 (ASP) | −2.942 | 0.450 | 1.532 | 55.800 |
| 8 (ASP) | 2.102 | 0.119 | | |
| 9 | ∞ | 0.110 | 1.518 | 64.141 |
| 10 | ∞ | 0.798 | | |

In the imaging lens 1, both surfaces (first surface, second surface) of the first lens L1, both surfaces (third surface, fourth surface) of the second lens L2, both surfaces (fifth surface, sixth surface) of the third lens L3, and both surfaces (seventh surface, eighth surface) of the fourth lens L4 are formed as an aspherical surface. Table 2 shows the 3-order to 16-order aspherical coefficients A3 to A16 of the aspherical surface in the numerical example 1 together with a conic constant κ.

TABLE 2

| Aspherical | | | | | | | | |
|---|---|---|---|---|---|---|---|---|
| coefficient | First surface | Second surface | Third surface | Fourth surface | Fifth surface | Sixth surface | Seventh surface | Eighth surface |
| κ(conic | −8.0509656 | −1.3954832 | 0.0000000 | 2.7641437 | 0.0000000 | −0.6869239 | 0.0000000 | −15.2999334 |
| constant) | | | | | | | | |
| A3 | 0.0000000 | 0.0000000 | 0.0000000 | 0.0000000 | 0.0000000 | 0.0000000 | 0.0000000 | 0.0471336 |
| A4 | 0.1641775 | 0.1308395 | 0.2033024 | 0.0821618 | −0.0533266 | 0.0914012 | −0.1554247 | −0.2535292 |
| A5 | 0.0000000 | 0.0000000 | 0.0000000 | 0.0000000 | 0.0000000 | 0.0000000 | 0.0000000 | 0.1720262 |
| A6 | −0.2678664 | −0.4886470 | −0.3305408 | 0.0718871 | −0.0027655 | −0.0623246 | 0.1470107 | 0.0024273 |
| A7 | 0.0000000 | 0.0000000 | 0.0000000 | 0.0000000 | 0.0000000 | 0.0000000 | 0.0000000 | −0.0378894 |
| A8 | 0.2152179 | 0.4608888 | 0.3415176 | −0.0041504 | 0.1847120 | 0.0852633 | −0.0595758 | 0.0045241 |
| A9 | 0.0000000 | 0.0000000 | 0.0000000 | 0.0000000 | 0.0000000 | 0.0000000 | 0.0000000 | 0.0049974 |
| A10 | −0.2491818 | −0.2429039 | −0.1001136 | 0.0081693 | −0.1208968 | −0.0181495 | 0.0119995 | −0.0013464 |
| A11 | 0.0000000 | 0.0000000 | 0.0000000 | 0.0000000 | 0.0000000 | 0.0000000 | 0.0000000 | 0.0000000 |
| A12 | 0.0000000 | 0.0000000 | 0.0000000 | 0.0000000 | 0.0000000 | −0.0060112 | −0.0010593 | 0.0000000 |
| A13 | 0.0000000 | 0.0000000 | 0.0000000 | 0.0000000 | 0.0000000 | 0.0000000 | 0.0000000 | 0.0000000 |
| A14 | 0.0000000 | 0.0000000 | 0.0000000 | 0.0000000 | 0.0000000 | 0.0014661 | 0.0000000 | 0.0000000 |
| A15 | 0.0000000 | 0.0000000 | 0.0000000 | 0.0000000 | 0.0000000 | 0.0000000 | 0.0000000 | 0.0000000 |
| A16 | 0.0000000 | 0.0000000 | 0.0000000 | 0.0000000 | 0.0000000 | 0.0000000 | 0.0000000 | 0.0000000 |

Table 3 shows an F-number Fno, a focal length f, and a viewing angle 2ω of the numerical example 1.

TABLE 3

| | |
|---|---|
| Fno | 2.5 |
| f | 3.8637 |
| 2ω | 71.659 |

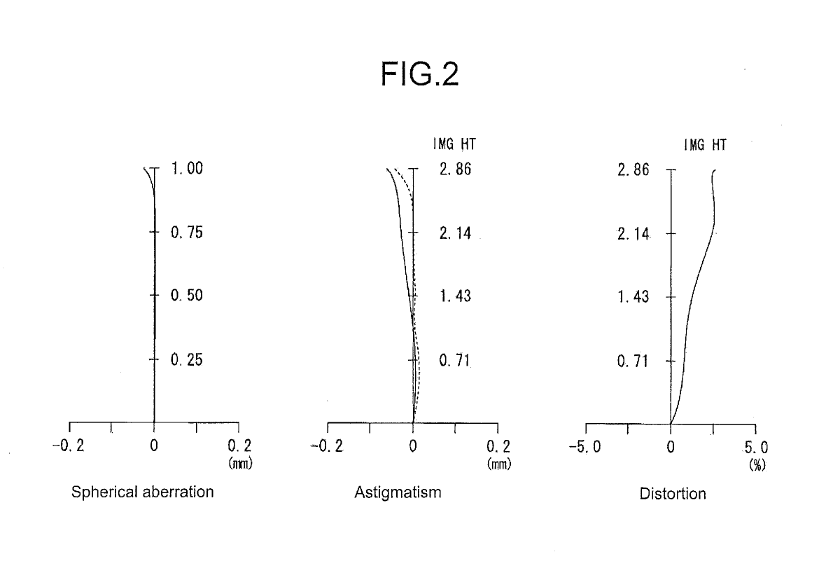

FIG. 2 shows various aberrations of the numerical example 1.

In an astigmatism diagram shown in FIG. 2, a solid line represents values in a sagittal image surface, and a broken line represents values in a meridional image surface.

As is apparent from the aberration diagrams, the numerical example 1 includes suitably compensated various aberrations and an excellent imaging performance.

### Second Embodiment

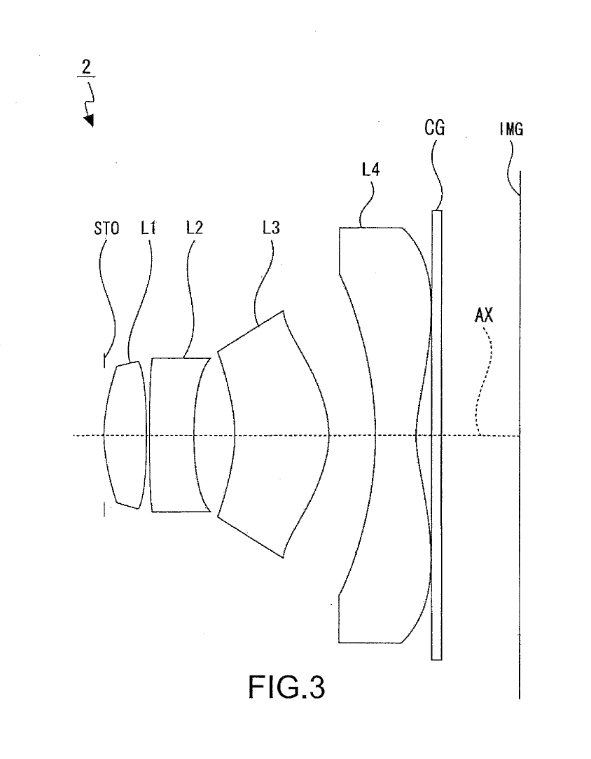

FIG. 3 shows a lens configuration of an imaging lens 2 according to a second embodiment of the present technology.

The imaging lens 2 includes, in order from an object side to an image side, an aperture stop STO, a first lens L1 formed in a biconvex shape having a positive refractive power, a second lens L2 formed in a biconcave shape having a negative refractive power, a third lens L3 formed in a meniscus shape having a positive refractive power with a convex surface faced to the image side, and a fourth lens L4 formed in a biconcave shape having a negative refractive power.

The aperture stop STO, the first lens L1, the second lens L2, the third lens L3, and the fourth lens L4 are disposed and fixed.

A cover glass CG is disposed between the fourth lens L4 and an image surface IMG.

Table 4 shows lens data of a numerical example 2 in which specific numeral values are applied to the imaging lens 2 according to the second embodiment.

TABLE 4

| Si | Ri | Di | Ni | νi |
|---|---|---|---|---|
| Stop | ∞ | 0 | | |
| 1 (ASP) | 1.561 | 0.468 | 1.532 | 55.800 |
| 2 (ASP) | −7.306 | 0.025 | | |
| 3 (ASP) | −1000.000 | 0.500 | 1.642 | 23.891 |
| 4 (ASP) | 3.571 | 0.449 | | |
| 5 (ASP) | −2.063 | 1.031 | 1.532 | 55.800 |
| 6 (ASP) | −1.175 | 0.491 | | |
| 7 (ASP) | −35.843 | 0.460 | 1.532 | 55.800 |
| 8 (ASP) | 1.572 | 0.167 | | |
| 9 | ∞ | 0.110 | 1.518 | 64.141 |
| 10 | ∞ | 0.868 | | |

In the imaging lens 2, both surfaces (first surface, second surface) of the first lens L1, both surfaces (third surface, fourth surface) of the second lens L2, both surfaces (fifth surface, sixth surface) of the third lens L3, and both surfaces (seventh surface, eighth surface) of the fourth lens L4 are formed as an aspherical surface. Table 5 shows the 3-order to 16-order aspherical coefficients A3 to A16 of the aspherical surface in the numerical example 2 together with a conic constant κ.

TABLE 5

| Aspherical | | | | | | | | |
|---|---|---|---|---|---|---|---|---|
| coefficient | First surface | Second surface | Third surface | Fourth surface | Fifth surface | Sixth surface | Seventh surface | Eighth surface |
| κ(conic | −5.9499693 | 44.3056917 | 0.0000000 | 6.0645971 | 0.0000000 | −0.6366576 | 0.0000000 | −8.2110331 |
| constant) | | | | | | | | |
| A3 | 0.0000000 | 0.0000000 | 0.0000000 | 0.0000000 | 0.0000000 | 0.0000000 | 0.0000000 | 0.0547653 |
| A4 | 0.1604997 | 0.0833872 | 0.1556436 | 0.0959446 | −0.0313293 | 0.0837500 | −0.2053066 | −0.2669058 |
| A5 | 0.0000000 | 0.0000000 | 0.0000000 | 0.0000000 | 0.0000000 | 0.0000000 | 0.0000000 | 0.1639755 |
| A6 | −0.2584098 | −0.5076687 | −0.3453552 | 0.0756418 | 0.0021983 | −0.0488682 | 0.1538399 | 0.0121647 |
| A7 | 0.0000000 | 0.0000000 | 0.0000000 | 0.0000000 | 0.0000000 | 0.0000000 | 0.0000000 | −0.0381548 |
| A8 | 0.2433299 | 0.4641004 | 0.3495755 | −0.0110266 | 0.1843985 | 0.0748730 | −0.0580713 | 0.0037115 |
| A9 | 0.0000000 | 0.0000000 | 0.0000000 | 0.0000000 | 0.0000000 | 0.0000000 | 0.0000000 | 0.0047442 |
| A10 | −0.4261018 | −0.2696174 | −0.0344052 | 0.0084584 | −0.1212723 | −0.0162090 | 0.0115665 | −0.0011888 |
| A11 | 0.0000000 | 0.0000000 | 0.0000000 | 0.0000000 | 0.0000000 | 0.0000000 | 0.0000000 | 0.0000000 |
| A12 | 0.0000000 | 0.0000000 | 0.0000000 | 0.0000000 | 0.0000000 | −0.0043919 | −0.0010018 | 0.0000000 |
| A13 | 0.0000000 | 0.0000000 | 0.0000000 | 0.0000000 | 0.0000000 | 0.0000000 | 0.0000000 | 0.0000000 |
| A14 | 0.0000000 | 0.0000000 | 0.0000000 | 0.0000000 | 0.0000000 | 0.0008340 | 0.0000000 | 0.0000000 |
| A15 | 0.0000000 | 0.0000000 | 0.0000000 | 0.0000000 | 0.0000000 | 0.0000000 | 0.0000000 | 0.0000000 |
| A16 | 0.0000000 | 0.0000000 | 0.0000000 | 0.0000000 | 0.0000000 | 0.0000000 | 0.0000000 | 0.0000000 |

Table 6 shows an F-number Fno, a focal length f, and a viewing angle 2ω of the numerical example 2.

TABLE 6

| | |
|---|---|
| Fno | 2.5 |
| f | 3.8566 |
| 2ω | 71.6956 |

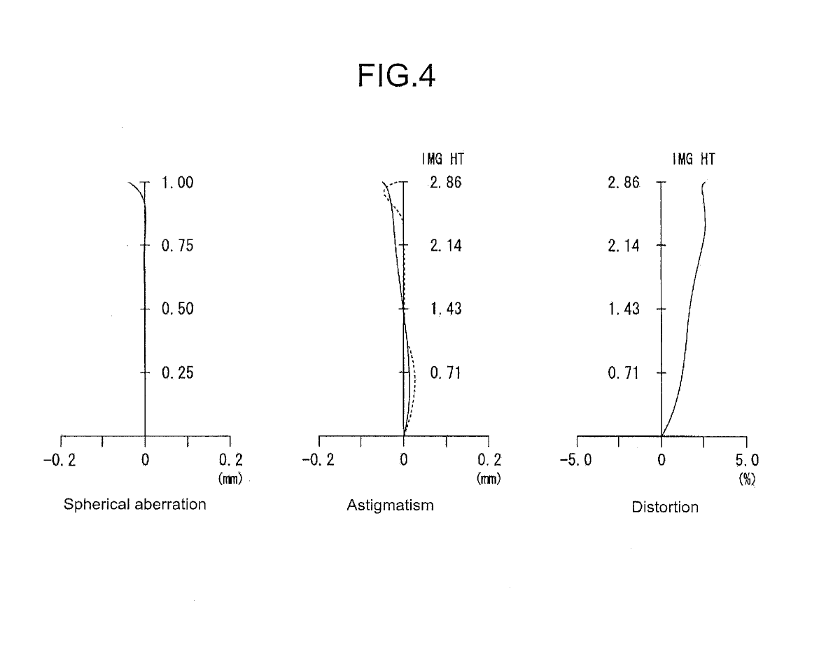

FIG. 4 shows various aberrations of the numerical example 2.

In an astigmatism diagram shown in FIG. 4, a solid line represents values in a sagittal image surface, and a broken line represents values in a meridional image surface.

As is apparent from the aberration diagrams, the numerical example 2 includes suitably compensated various aberrations and an excellent imaging performance.

### Third Embodiment

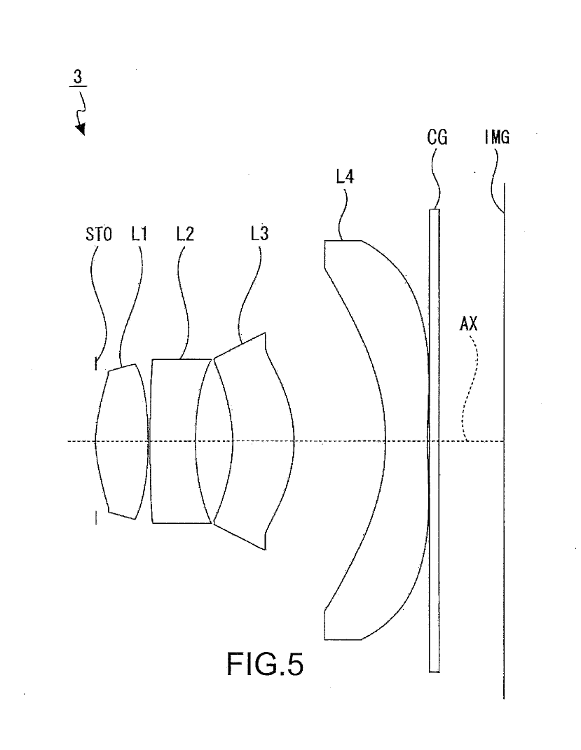

FIG. 5 shows a lens configuration of an imaging lens 3 according to a third embodiment of the present technology.

The imaging lens 3 includes, in order from an object side to an image side, an aperture stop STO, a first lens L1 formed in a biconvex shape having a positive refractive power, a second lens L2 formed in a biconcave shape having a negative refractive power, a third lens L3 formed in a meniscus shape having a positive refractive power with a convex surface faced to the image side, and a fourth lens L4 formed in a biconcave shape having a negative refractive power.

The aperture stop STO, the first lens L1, the second lens L2, the third lens L3, and the fourth lens L4 are disposed and fixed.

A cover glass CG is disposed between the fourth lens L4 and an image surface IMG.

Table 7 shows lens data of a numerical example 3 in which specific numeral values are applied to the imaging lens 3 according to the third embodiment.

TABLE 7

| Si | Ri | Di | Ni | νi |
|---|---|---|---|---|
| Stop | ∞ | 0 | | |
| 1 (ASP) | 1.787 | 0.590 | 1.532 | 55.800 |
| 2 (ASP) | −3.269 | 0.025 | | |
| 3 (ASP) | −20.338 | 0.500 | 1.642 | 23.891 |
| 4 (ASP) | 3.023 | 0.423 | | |
| 5 (ASP) | −1.841 | 0.695 | 1.532 | 55.800 |
| 6 (ASP) | −1.326 | 1.023 | | |
| 7 (ASP) | −3.439 | 0.450 | 1.532 | 55.800 |
| 8 (ASP) | 5.731 | 0.026 | | |
| 9 | ∞ | 0.110 | 1.518 | 64.141 |
| 10 | ∞ | 0.725 | | |

In the imaging lens 3, both surfaces (first surface, second surface) of the first lens L1, both surfaces (third surface, fourth surface) of the second lens L2, both surfaces (fifth surface, sixth surface) of the third lens L3, and both surfaces (seventh surface, eighth surface) of the fourth lens L4 are formed as an aspherical surface. Table 8 shows the 3-order to 16-order aspherical coefficients A3 to A16 of the aspherical surface in the numerical example 3 together with a conic constant κ.

TABLE 8

| Aspherical | | | | | | | | |
|---|---|---|---|---|---|---|---|---|
| coefficient | First surface | Second surface | Third surface | Fourth surface | Fifth surface | Sixth surface | Seventh surface | Eighth surface |
| κ(conic | −9.4976246 | −3.2540084 | 0.0000000 | −4.9786600 | 0.0000000 | −0.5892420 | 0.0000000 | −577.8955140 |
| constant) | | | | | | | | |
| A3 | 0.0000000 | 0.0000000 | 0.0000000 | 0.0000000 | 0.0000000 | 0.0000000 | 0.0000000 | 0.2312456 |
| A4 | 0.1669478 | 0.1369559 | 0.1810690 | 0.0572451 | −0.0634798 | 0.0123343 | −0.1583523 | −0.5147146 |
| A5 | 0.0000000 | 0.0000000 | 0.0000000 | 0.0000000 | 0.0000000 | 0.0000000 | 0.0000000 | 0.3082312 |
| A6 | −0.2733537 | −0.5002748 | −0.3571026 | 0.0660807 | 0.0234001 | 0.0103802 | 0.1430806 | −0.0188218 |
| A7 | 0.0000000 | 0.0000000 | 0.0000000 | 0.0000000 | 0.0000000 | 0.0000000 | 0.0000000 | −0.0383142 |
| A8 | 0.2408895 | 0.4505438 | 0.3311374 | −0.0591478 | 0.2503953 | 0.0633824 | −0.0578695 | 0.0039588 |
| A9 | 0.0000000 | 0.0000000 | 0.0000000 | 0.0000000 | 0.0000000 | 0.0000000 | 0.0000000 | 0.0042707 |
| A10 | −0.2382471 | −0.2132638 | −0.0752137 | 0.0524239 | −0.1387671 | 0.0008006 | 0.0113160 | −0.0010263 |
| A11 | 0.0000000 | 0.0000000 | 0.0000000 | 0.0000000 | 0.0000000 | 0.0000000 | 0.0000000 | 0.0000000 |
| A12 | 0.0000000 | 0.0000000 | 0.0000000 | 0.0000000 | 0.0000000 | 0.0014261 | −0.0008473 | 0.0000000 |
| A13 | 0.0000000 | 0.0000000 | 0.0000000 | 0.0000000 | 0.0000000 | 0.0000000 | 0.0000000 | 0.0000000 |
| A14 | 0.0000000 | 0.0000000 | 0.0000000 | 0.0000000 | 0.0000000 | −0.0067990 | 0.0000000 | 0.0000000 |
| A15 | 0.0000000 | 0.0000000 | 0.0000000 | 0.0000000 | 0.0000000 | 0.0000000 | 0.0000000 | 0.0000000 |
| A16 | 0.0000000 | 0.0000000 | 0.0000000 | 0.0000000 | 0.0000000 | 0.0000000 | 0.0000000 | 0.0000000 |

Table 9 shows an F-number Fno, a focal length f, and a viewing angle 2ω of the numerical example 3.

TABLE 9

| | |
|---|---|
| Fno | 2.56 |
| f | 3.982 |
| 2ω | 69.9766 |

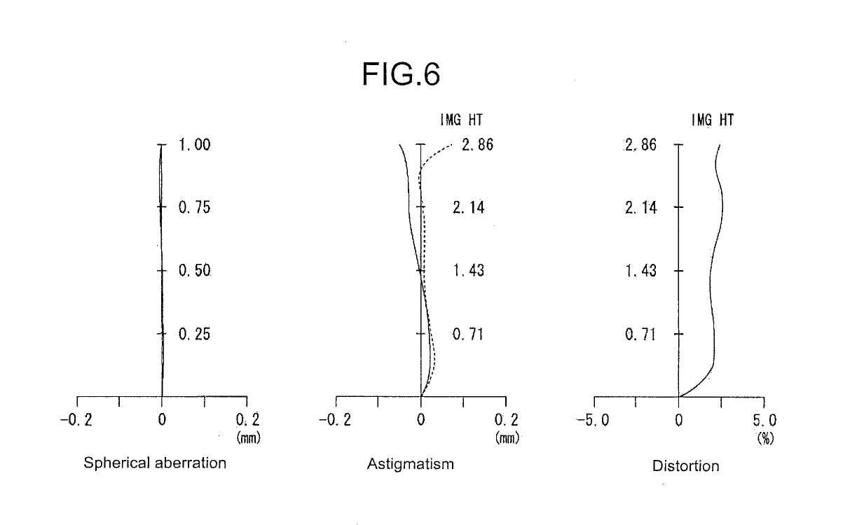

FIG. 6 shows various aberrations of the numerical example 3.

In an astigmatism diagram shown in FIG. 6, a solid line represents values in a sagittal image surface, and a broken line represents values in a meridional image surface.

As is apparent from the aberration diagrams, the numerical example 3 includes suitably compensated various aberrations and an excellent imaging performance.

### Fourth Embodiment

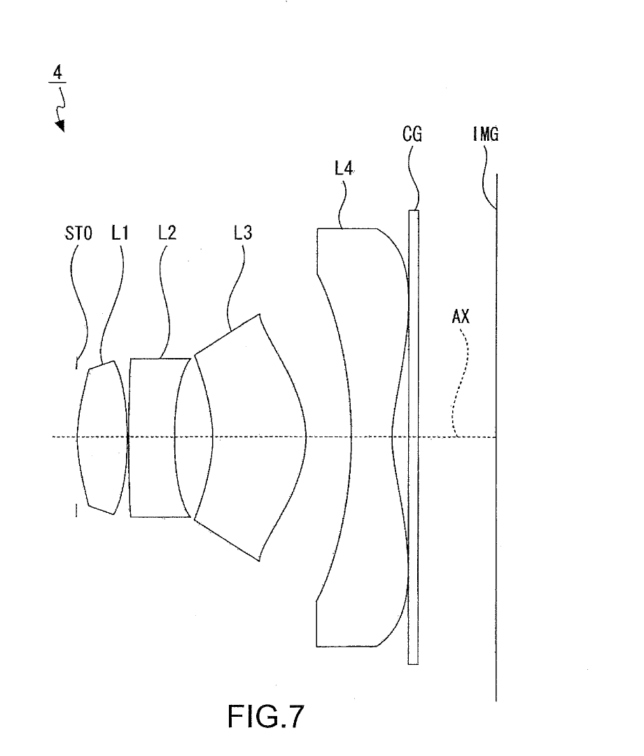

FIG. 7 shows a lens configuration of an imaging lens 4 according to a fourth embodiment of the present technology.

The imaging lens 4 includes, in order from an object side to an image side, an aperture stop STO, a first lens L1 formed in a biconvex shape having a positive refractive power, a second lens L2 formed in a biconcave shape having a negative refractive power, a third lens L3 formed in a meniscus shape having a positive refractive power with a convex surface faced to the image side, and a fourth lens L4 formed in a biconcave shape having a negative refractive power.

The aperture stop STO, the first lens L1, the second lens L2, the third lens L3, and the fourth lens L4 are disposed and fixed.

A cover glass CG is disposed between the fourth lens L4 and an image surface IMG.

Table 10 shows lens data of a numerical example 4 in which specific numeral values are applied to the imaging lens 4 according to the fourth embodiment.

TABLE 10

| Si | Ri | Di | Ni | νi |
|---|---|---|---|---|
| Stop | ∞ | 0 | | |
| 1 (ASP) | 1.669 | 0.558 | 1.532 | 55.800 |
| 2 (ASP) | −3.128 | 0.025 | | |
| 3 (ASP) | −8.251 | 0.500 | 1.642 | 23.891 |
| 4 (ASP) | 3.830 | 0.406 | | |
| 5 (ASP) | −1.957 | 1.031 | 1.532 | 55.800 |
| 6 (ASP) | −1.162 | 0.491 | | |
| 7 (ASP) | −60.144 | 0.452 | 1.532 | 55.800 |
| 8 (ASP) | 1.506 | 0.184 | | |
| 9 | ∞ | 0.110 | 1.518 | 64.141 |
| 10 | ∞ | 0.843 | | |

In the imaging lens 4, both surfaces (first surface, second surface) of the first lens L1, both surfaces (third surface, fourth surface) of the second lens L2, both surfaces (fifth surface, sixth surface) of the third lens L3, and both surfaces (seventh surface, eighth surface) of the fourth lens L4 are formed as an aspherical surface. Table 11 shows the 3-order to 16-order aspherical coefficients A3 to A16 of the aspherical surface in the numerical example 4 together with a conic constant κ.

TABLE 11

| Aspherical | | | | | | | | |
|---|---|---|---|---|---|---|---|---|
| coefficient | First surface | Second surface | Third surface | Fourth surface | Fifth surface | Sixth surface | Seventh surface | Eighth surface |
| κ(conic | −7.9023584 | 0.4409499 | 0.0000000 | 4.1267591 | 0.0000000 | −0.6698805 | 0.0000000 | −6.0211025 |
| constant) | | | | | | | | |
| A3 | 0.0000000 | 0.0000000 | 0.0000000 | 0.0000000 | 0.0000000 | 0.0000000 | 0.0000000 | 0.0077615 |
| A4 | 0.1601072 | 0.1214131 | 0.1976673 | 0.0852796 | −0.0383988 | 0.0850129 | −0.1990463 | −0.2225430 |
| A5 | 0.0000000 | 0.0000000 | 0.0000000 | 0.0000000 | 0.0000000 | 0.0000000 | 0.0000000 | 0.1508529 |
| A6 | −0.2761895 | −0.5056990 | −0.3332447 | 0.0844189 | −0.0060206 | −0.0531065 | 0.1520991 | 0.0108094 |
| A7 | 0.0000000 | 0.0000000 | 0.0000000 | 0.0000000 | 0.0000000 | 0.0000000 | 0.0000000 | −0.0369463 |
| A8 | 0.2032307 | 0.4590545 | 0.3495823 | −0.0012799 | 0.2437116 | 0.0815631 | −0.0588222 | 0.0039327 |
| A9 | 0.0000000 | 0.0000000 | 0.0000000 | 0.0000000 | 0.0000000 | 0.0000000 | 0.0000000 | 0.0044918 |
| A10 | −0.3067366 | −0.2548169 | −0.0836089 | −0.0059253 | −0.1620628 | −0.0182347 | 0.0119691 | −0.0011440 |
| A11 | 0.0000000 | 0.0000000 | 0.0000000 | 0.0000000 | 0.0000000 | 0.0000000 | 0.0000000 | 0.0000000 |
| A12 | 0.0000000 | 0.0000000 | 0.0000000 | 0.0000000 | 0.0000000 | −0.0056747 | −0.0010627 | 0.0000000 |
| A13 | 0.0000000 | 0.0000000 | 0.0000000 | 0.0000000 | 0.0000000 | 0.0000000 | 0.0000000 | 0.0000000 |
| A14 | 0.0000000 | 0.0000000 | 0.0000000 | 0.0000000 | 0.0000000 | 0.0012239 | 0.0000000 | 0.0000000 |
| A15 | 0.0000000 | 0.0000000 | 0.0000000 | 0.0000000 | 0.0000000 | 0.0000000 | 0.0000000 | 0.0000000 |
| A16 | 0.0000000 | 0.0000000 | 0.0000000 | 0.0000000 | 0.0000000 | 0.0000000 | 0.0000000 | 0.0000000 |

Table 12 shows an F-number Fno, a focal length f, and a viewing angle 2ω of the numerical example 4.

TABLE 12

| | |
|---|---|
| Fno | 2.6431 |
| f | 3.8617 |
| 2ω | 71.6254 |

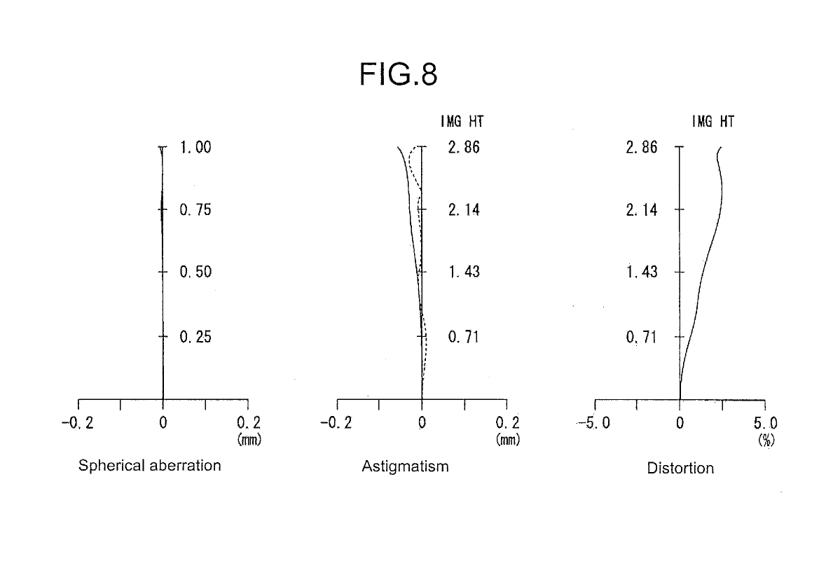

FIG. 8 shows various aberrations of the numerical example 4.

In an astigmatism diagram shown in FIG. 8, a solid line represents values in a sagittal image surface, and a broken line represents values in a meridional image surface.

As is apparent from the aberration diagrams, the numerical example 4 includes suitably compensated various aberrations and an excellent imaging performance.

### Fifth Embodiment

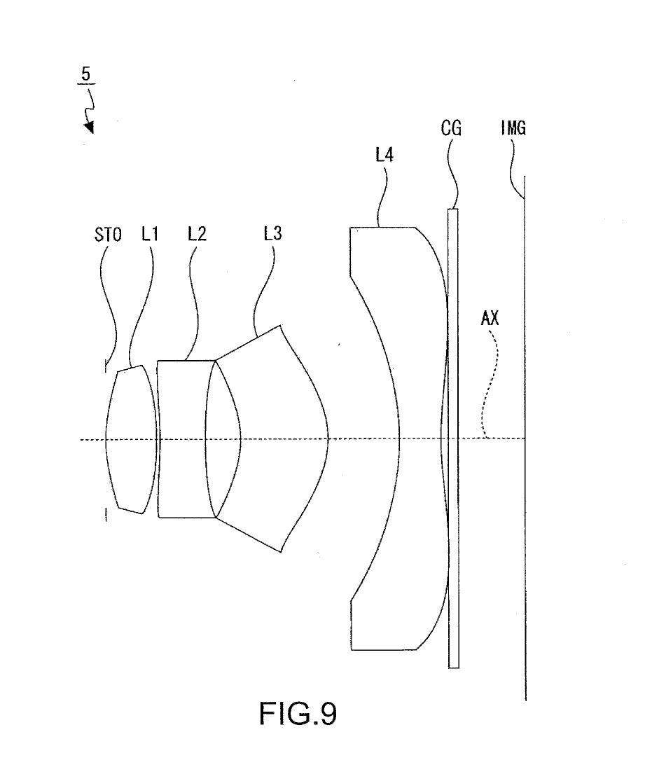

FIG. 9 shows a lens configuration of an imaging lens 5 according to a fifth embodiment of the present technology.

The imaging lens 5 includes, in order from an object side to an image side, an aperture stop STO, a first lens L1 formed in a biconvex shape having a positive refractive power, a second lens L2 formed in a biconcave shape having a negative refractive power, a third lens L3 formed in a meniscus shape having a positive refractive power with a convex surface faced to the image side, and a fourth lens L4 formed in a biconcave shape having a negative refractive power.

The aperture stop STO, the first lens L1, the second lens L2, the third lens L3, and the fourth lens L4 are disposed and fixed.

A cover glass CG is disposed between the fourth lens L4 and an image surface IMG.

Table 13 shows lens data of a numerical example 5 in which specific numeral values are applied to the imaging lens 5 according to the fifth embodiment.

TABLE 13

| Si | Ri | Di | Ni | Vi |
|---|---|---|---|---|
| Stop | ∞ | 0 | | |
| 1 (ASP) | 1.673 | 0.572 | 1.532 | 55.800 |
| 2 (ASP) | −2.671 | 0.025 | | |
| 3 (ASP) | −4.011 | 0.500 | 1.642 | 23.891 |
| 4 (ASP) | 9.830 | 0.389 | | |
| 5 (ASP) | −1.479 | 0.950 | 1.532 | 55.800 |
| 6 (ASP) | −1.133 | 0.801 | | |
| 7 (ASP) | −2.942 | 0.450 | 1.532 | 55.800 |
| 8 (ASP) | 2.997 | 0.078 | | |
| 9 | ∞ | 0.110 | 1.518 | 64.141 |
| 10 | ∞ | 0.725 | | |

In the imaging lens 5, both surfaces (first surface, second surface) of the first lens L1, both surfaces (third surface, fourth surface) of the second lens L2, both surfaces (fifth surface, sixth surface) of the third lens L3, and both surfaces (seventh surface, eighth surface) of the fourth lens L4 are formed as an aspherical surface. Table 14 shows the 3-order to 16-order aspherical coefficients A3 to A16 of the aspherical surface in the numerical example 5 together with a conic constant κ.

TABLE 14

| Aspherical | | | | | | | | |
|---|---|---|---|---|---|---|---|---|
| coefficient | First surface | Second surface | Third surface | Fourth surface | Fifth surface | Sixth surface | Seventh surface | Eighth surface |
| κ(conic | −7.3639027 | −0.9972342 | 0.0000000 | 12.7575574 | 0.0000000 | −0.6240944 | 0.0000000 | −5.3154913 |
| constant) | | | | | | | | |
| A3 | 0.0000000 | 0.0000000 | 0.0000000 | 0.0000000 | 0.0000000 | 0.0000000 | 0.0000000 | 0.0266122 |
| A4 | 0.1524171 | 0.1308547 | 0.2267633 | 0.0895265 | −0.0753742 | 0.0560641 | −0.0871568 | −0.2670218 |
| A5 | 0.0000000 | 0.0000000 | 0.0000000 | 0.0000000 | 0.0000000 | 0.0000000 | 0.0000000 | 0.1863770 |
| A6 | −0.2788927 | −0.5164015 | −0.3220241 | 0.0689241 | 0.0393436 | −0.0227267 | 0.1106396 | 0.0068851 |
| A7 | 0.0000000 | 0.0000000 | 0.0000000 | 0.0000000 | 0.0000000 | 0.0000000 | 0.0000000 | −0.0402768 |
| A8 | 0.2243958 | 0.4505594 | 0.3449405 | 0.0706421 | 0.2463909 | 0.0703993 | −0.0519872 | 0.0034727 |
| A9 | 0.0000000 | 0.0000000 | 0.0000000 | 0.0000000 | 0.0000000 | 0.0000000 | 0.0000000 | 0.0052119 |
| A10 | −0.3638538 | −0.2509092 | −0.0759794 | −0.0291239 | −0.1281341 | −0.0149801 | 0.0117597 | −0.0012491 |
| A11 | 0.0000000 | 0.0000000 | 0.0000000 | 0.0000000 | 0.0000000 | 0.0000000 | 0.0000000 | 0.0000000 |
| A12 | 0.0000000 | 0.0000000 | 0.0000000 | 0.0000000 | 0.0000000 | −0.0027124 | −0.0011211 | 0.0000000 |
| A13 | 0.0000000 | 0.0000000 | 0.0000000 | 0.0000000 | 0.0000000 | 0.0000000 | 0.0000000 | 0.0000000 |
| A14 | 0.0000000 | 0.0000000 | 0.0000000 | 0.0000000 | 0.0000000 | −0.0004491 | 0.0000000 | 0.0000000 |
| A15 | 0.0000000 | 0.0000000 | 0.0000000 | 0.0000000 | 0.0000000 | 0.0000000 | 0.0000000 | 0.0000000 |
| A16 | 0.0000000 | 0.0000000 | 0.0000000 | 0.0000000 | 0.0000000 | 0.0000000 | 0.0000000 | 0.0000000 |

Table 15 shows an F-number Fno, a focal length f, and a viewing angle 2ω of the numerical example 5.

TABLE 15

| | |
|---|---|
| Fno | 2.6581 |
| f | 3.8836 |
| 2ω | 71.266 |

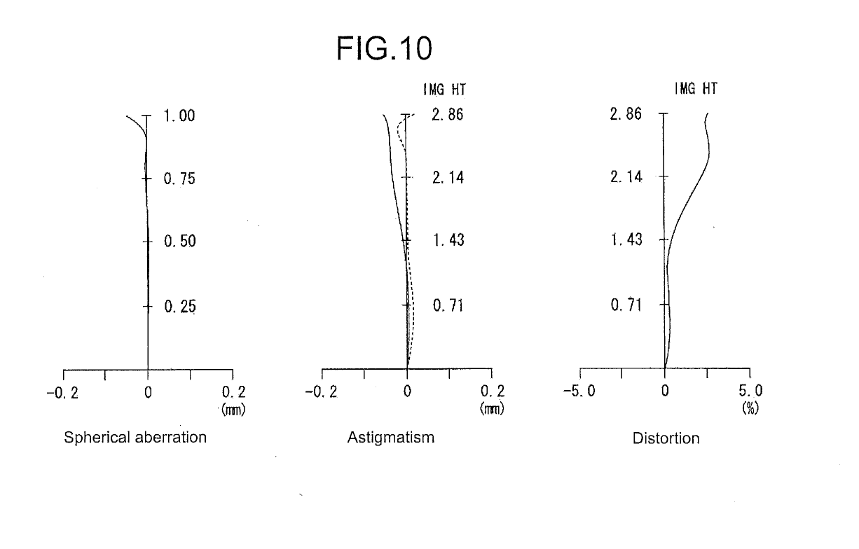

FIG. 10 shows various aberrations of the numerical example 5.

In an astigmatism diagram shown in FIG. 10, a solid line represents values in a sagittal image surface, and a broken line represents values in a meridional image surface.

As is apparent from the aberration diagrams, the numerical example 5 includes suitably compensated various aberrations and an excellent imaging performance.

### Sixth Embodiment

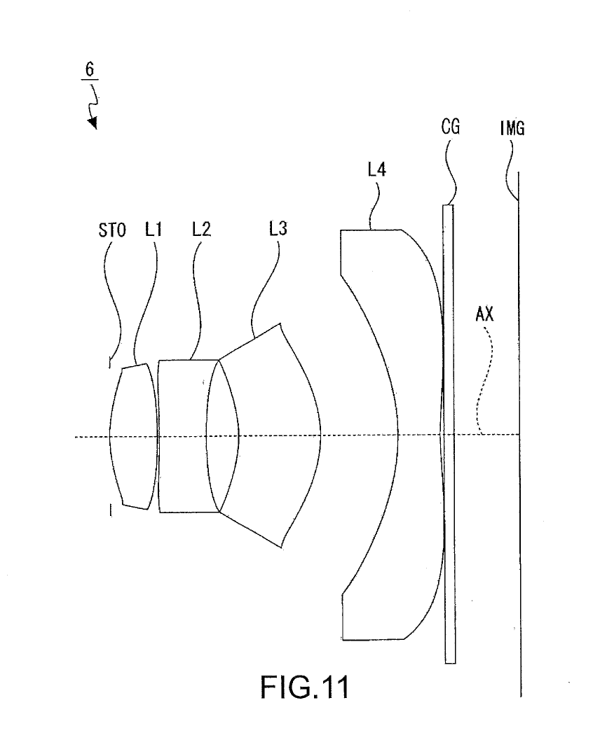

FIG. 11 shows a lens configuration of an imaging lens 6 according to a sixth embodiment of the present technology.

The imaging lens 6 includes, in order from an object side to an image side, an aperture stop STO, a first lens L1 formed in a biconvex shape having a positive refractive power, a second lens L2 formed in a biconcave shape having a negative refractive power, a third lens L3 formed in a meniscus shape having a positive refractive power with a convex surface faced to the image side, and a fourth lens L4 formed in a biconcave shape having a negative refractive power.

The aperture stop STO, the first lens L1, the second lens L2, the third lens L3, and the fourth lens L4 are disposed and fixed.

A cover glass CG is disposed between the fourth lens L4 and an image surface IMG.

Table 16 shows lens data of a numerical example 6 in which specific numeral values are applied to the imaging lens 6 according to the sixth embodiment.

TABLE 16

| Si | Ri | Di | Ni | Vi |
|---|---|---|---|---|
| Stop | ∞ | 0 | | |
| 1 (ASP) | 1.533 | 0.529 | 1.532 | 55.800 |
| 2 (ASP) | −3.832 | 0.025 | | |
| 3 (ASP) | −6.006 | 0.500 | 1.642 | 23.891 |
| 4 (ASP) | 6.006 | 0.358 | | |
| 5 (ASP) | −1.717 | 0.900 | 1.532 | 55.800 |
| 6 (ASP) | −1.281 | 0.851 | | |
| 7 (ASP) | −2.942 | 0.450 | 1.532 | 55.800 |
| 8 (ASP) | 3.763 | 0.049 | | |
| 9 | ∞ | 0.110 | 1.518 | 64.141 |
| 10 | ∞ | 0.725 | | |

In the imaging lens 6, both surfaces (first surface, second surface) of the first lens L1, both surfaces (third surface, fourth surface) of the second lens L2, both surfaces (fifth surface, sixth surface) of the third lens L3, and both surfaces (seventh surface, eighth surface) of the fourth lens L4 are formed as an aspherical surface. Table 17 shows the 3-order to 16-order aspherical coefficients A3 to A16 of the aspherical surface in the numerical example 6 together with a conic constant κ.

TABLE 17

| Aspherical | | | | | | | | |
|---|---|---|---|---|---|---|---|---|
| coefficient | First surface | Second surface | Third surface | Fourth surface | Fifth surface | Sixth surface | Seventh surface | Eighth surface |
| κ(conic | −5.4913436 | 0.9943433 | 0.0000000 | 25.1773172 | 0.0000000 | −0.5304518 | 0.0000000 | −0.5079931 |
| constant) | | | | | | | | |
| A3 | 0.0000000 | 0.0000000 | 0.0000000 | 0.0000000 | 0.0000000 | 0.0000000 | 0.0000000 | 0.0615419 |
| A4 | 0.1619725 | 0.1248392 | 0.2035134 | 0.0885265 | −0.0701265 | 0.0365351 | −0.1234083 | −0.3264028 |
| A5 | 0.0000000 | 0.0000000 | 0.0000000 | 0.0000000 | 0.0000000 | 0.0000000 | 0.0000000 | 0.2033283 |
| A6 | −0.2618603 | −0.5223420 | −0.3335133 | 0.0526119 | 0.0135126 | −0.0055820 | 0.1188594 | 0.0057005 |
| A7 | 0.0000000 | 0.0000000 | 0.0000000 | 0.0000000 | 0.0000000 | 0.0000000 | 0.0000000 | −0.0395286 |
| A8 | 0.2684214 | 0.4446934 | 0.3320846 | 0.0947837 | 0.2188109 | 0.0544897 | −0.0494005 | 0.0031164 |
| A9 | 0.0000000 | 0.0000000 | 0.0000000 | 0.0000000 | 0.0000000 | 0.0000000 | 0.0000000 | 0.0051550 |
| A10 | −0.4375812 | −0.2532409 | −0.0323773 | −0.0270898 | −0.0995377 | −0.0101137 | 0.0104281 | −0.0012202 |
| A11 | 0.0000000 | 0.0000000 | 0.0000000 | 0.0000000 | 0.0000000 | 0.0000000 | 0.0000000 | 0.0000000 |
| A12 | 0.0000000 | 0.0000000 | 0.0000000 | 0.0000000 | 0.0000000 | 0.0023005 | −0.0009187 | 0.0000000 |
| A13 | 0.0000000 | 0.0000000 | 0.0000000 | 0.0000000 | 0.0000000 | 0.0000000 | 0.0000000 | 0.0000000 |
| A14 | 0.0000000 | 0.0000000 | 0.0000000 | 0.0000000 | 0.0000000 | −0.0034222 | 0.0000000 | 0.0000000 |
| A15 | 0.0000000 | 0.0000000 | 0.0000000 | 0.0000000 | 0.0000000 | 0.0000000 | 0.0000000 | 0.0000000 |
| A16 | 0.0000000 | 0.0000000 | 0.0000000 | 0.0000000 | 0.0000000 | 0.0000000 | 0.0000000 | 0.0000000 |

Table 18 shows an F-number Fno, a focal length f, and a viewing angle 2ω of the numerical example 6.

TABLE 18

| | |
|---|---|
| Fno | 2.6718 |
| f | 3.9036 |
| 2ω | 71.2424 |

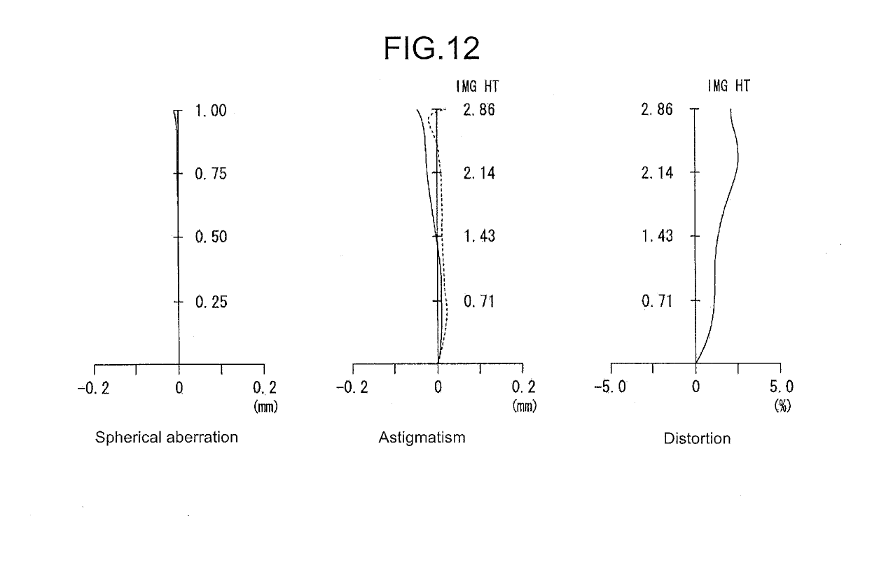

FIG. 12 shows various aberrations of the numerical example 6.

In an astigmatism diagram shown in FIG. 12, a solid line represents values in a sagittal image surface, and a broken line represents values in a meridional image surface.

As is apparent from the aberration diagrams, the numerical example 6 includes suitably compensated various aberrations and an excellent imaging performance.

### [Values of Conditional Expressions of Imaging Lens]

Hereinafter, various values of the conditional expressions of the imaging lens according to an embodiment of the present technology are described.

Table 19 shows various values of the conditional expressions (1) to (6) of the imaging lenses 1 to 6 (numerical examples 1 to 6).

TABLE 19

| | Conditional expression | Example 1 | Example 2 | Example 3 | Example 4 | Example 5 | Example 6 |
|---|---|---|---|---|---|---|---|
| (1) | 0 ≦ (R2 + R1)/(R2 − R1) ≦ 1 | 0.229 | 0.648 | 0.293 | 0.304 | 0.229 | 0.428 |
| (2) | R3 ≦ 0 | −5.71 | −1000 | −20.33 | −8.25 | −4.01 | −6 |
| (3) | 0.1 < D34/f < 0.3 | 0.1205 | 0.127 | 0.2569 | 0.127 | 0.206 | 0.218 |
| (4) | −8 ≦ (R6 + R5)/(R6 − R5) ≦ −2 | −2.84 | −3.64 | −6.14 | −3.92 | −7.55 | −6.86 |
| (5) | R7 ≦ 0 | −2.94 | −35.8 | −3.43 | −60.14 | −2.94 | −2.94 |
| (6) | 0 < D34 − D23 | 0.085 | 0.042 | 0.6 | 0.085 | 0.412 | 0.493 |

As is apparent from Table 19, the imaging lenses 1 to 6 satisfy the conditional expressions (1) to (6).

### [Configuration of Imaging Apparatus]

In the imaging apparatus according to an embodiment of the present technology, the imaging lens includes, in order from an object side to an image side, an aperture stop, a first lens formed in a biconvex shape having a positive refractive power, a second lens having a negative refractive power and a surface on the image side formed on a concave surface, a third lens formed in a meniscus shape having a positive refractive power with a convex surface faced to the image side, and a fourth lens having a negative refractive power and a surface on the image side formed on a concave surface.

In the imaging apparatus according to an embodiment of the present technology, the aperture stop is disposed to the object side than the first lens, so that an entrance pupil position can be set at a position distant from the image surface and high telecentricity can be ensured, which makes it possible to optimize an incident angle to the image surface.

In the imaging apparatus according to an embodiment of the present technology, the imaging lens satisfies the following conditional expressions (1) to (5):

0≦(R2+R1)/(R2−R1)≦1 (1)

R3≦0 (2)

0.1<D34/f<0.3 (3)

−8≦(R6+R5)/(R6−R5)≦−2 (4)

R7≦0 (5)

where
R1: a radius of curvature of a surface on the object side in the first lens,
R2: a radius of curvature of a surface on the image side in the first lens,
R3: a radius of curvature of a surface on the object side in the second lens,
f: a focal length of an entire lens system,
D34: an air interval between the third lens and the fourth lens,
R5: a radius of curvature of a surface on the object side in the third lens,
R6: a radius of curvature of a surface on the image side in the third lens, and
R7: a radius of curvature of a surface on the object side in the fourth lens.

The conditional expression (1) is an expression for defining a relationship between radius of curvature of the surface on the object side and the surface on the image side of the first lens and for limiting the shape of the first lens.

The shape of the first lens produces a significant effect on the aberration compensation of the entire imaging lens. Specifically, unless a shape balance is set so as to be a minimum angle of deviation with respect to on-axial peripheral rays in the first lens, it is difficult to compensate spherical aberration. When the balance is set to exceed the conditional expression (1), it is necessary to make the refractive power of the second lens larger than necessary, thereby causing significant coma aberration and astigmatism which are off-axis aberration in the second lens.

As a result, when the value of the conditional expression (1) exceeds a specified range, it is difficult to suppress a generation of high order aberrations and specifically it may be difficult to compensate the spherical aberration.

Therefore, the imaging lens satisfies the conditional expression (1), which eliminates the necessity to make the refractive power of the second lens larger than necessary and suppresses the generation of the coma aberration and the astigmatism which are the off-axis aberration in the second lens, and it is possible to suppress a generation of high order aberrations and specifically compensate spherical aberration suitably.

It should be noted that in the imaging lens according to an embodiment of the present technology, in order to improve the optical performance by further suppressing the generation of the spherical aberration and the like, it is more suitable that the conditional expression (1) is set to (1)′ 0.1≦(R2+R1)/(R2−R1)≦0.8.

Moreover, in the imaging apparatus according to an embodiment of the present technology, in order to further improve the optical performance by further suppressing the generation of the spherical aberration and the like, it is more suitable that the conditional expression (1) is set to (1)″ 0.229≦(R2+R1)/(R2−R1)≦0.648.

The conditional expression (2) is an expression for defining a radius of curvature of the surface on the object side of the second lens.

In the imaging apparatus according to an embodiment of the present technology, the second lens has a smaller Abbe number than other lenses.

Therefore, when the negative refractive power of the surface on the object side in the second lens is weakened beyond a specified range by exceeding the range of the conditional expression (2), the refractive power with respect to an F-line and a g-line becomes weak and axial chromatic aberration is likely to occur.

Moreover, although the refractive power can be shared on the surface on the image side in the second lens by bending, it is not easy to compensate the aberration in comparison with a case where a divergent function of the second lens is attempted to be provided to the both surfaces.

Therefore, the imaging lens satisfies the conditional expression (2), so that the generation of the axial chromatic aberration can be suppressed.

Moreover, in the imaging apparatus according to an embodiment of the present technology, in order to further improve the optical performance by further suppressing the generation of the axial chromatic aberration, it is more suitable that the conditional expression (2) is set to (2)′ −1000≦R3≦−4.0.

The conditional expression (3) is an expression for defining a relationship between the focal length f of the entire lens system and the air interval between the third lens and the fourth lens.

In the imaging apparatus according to an embodiment of the present technology, in order to reduce the size, the refractive power of a lens is distributed to positive, negative, positive, and negative powers in order from the object side to the image side, and the air interval between the third lens and the fourth lens is further widen as much as possible, thereby realizing a so-called telephoto type.

Moreover, since the refractive power of the fourth lens can be reduced by widening the air interval between the third lens and the fourth lens as much as possible, it is advantageous to compensate the entire aberration.

However, when the value of the air interval expressed by the conditional expression (3) exceeds the specified range, it is difficult to ensure suitable thicknesses of the centers of the lenses from the first lens to the fourth lens by reducing the overall length and manufacturing difficulty increases.

Therefore, the imaging lens satisfies the conditional expression (3), so that it is possible to compensate the entire aberration suitably and decrease the manufacturing difficulty.

It should be noted that in the imaging apparatus according to an embodiment of the present technology, in order to ensure a good optical performance and suitable thicknesses of the centers of the lenses, it is more suitable that the conditional expression (3) is set to (3)′ 0.12<D34/f<0.26.

The conditional expression (4) is an expression for defining a relationship between radius of curvature of the surface on the object side and the surface on the image side of the third lens and for limiting the shape of the third lens.

In the imaging apparatus according to an embodiment of the present technology, by forming the surface on the object side in the third lens to be a concave surface, it is possible to form a diverging surface which is a symmetrical system in a lens system together with the concave surface on the image side surface in the second lens. As a typical lens configuration of the symmetrical system, a Gauss type is known. By forming a lens surface (diverging surface) of the symmetrical system, the upper and lower rays can be compensated, and the spherical aberration, the coma aberration, and field curvature can be compensated well.

As a result, when the value of the conditional expression (4) exceeds a specified range, it is difficult to suppress a generation of high order aberrations and specifically it may be difficult to compensate the spherical aberration and the coma aberration.

Therefore, the imaging lens satisfies the conditional expression (4), so that the generation of high order aberrations is suppressed and the spherical aberration and the coma aberration can be compensated well.

The conditional expression (5) is an expression for defining a radius of curvature of the surface on the object side of the fourth lens.

In the imaging apparatus according to an embodiment of the present technology, by forming the surface on the object side in the fourth lens to be a concave surface, an incident angle of principal ray can be made nearly vertical in a viewing angle from an on-axis to a most peripheral image height. The way of the ray passage can avoid refraction of the ray more than necessary and distortion can be compensated.

Moreover, the effect of the concave surface is specifically beneficial to the ray in a sagittal direction, and sagittal coma flare which tends to occur at a wide viewing angle can be suppressed.

As a result, when the value of the conditional expression (5) exceeds a specified range, an angle at which peripheral ray is incident on the surface on the object side becomes large and it is difficult to compensate the distortion and the sagittal coma.

Therefore, the imaging lens satisfies the conditional expression (5), so that the refraction of the ray more than necessary can be avoided, the distortion can be compensated, which is beneficial to the ray in a sagittal direction, and the sagittal coma can be compensated well.

It should be noted that in the imaging apparatus according to an embodiment of the present technology, in order to improve the optical performance by further compensating the aberration, it is more suitable that the conditional expression (5) is set to (5)′ −65≦R7≦−2.

As described above, the imaging apparatus according to an embodiment of the present technology includes, in order from the object side to the image side, the aperture stop, the first lens formed in a biconvex shape having a positive refractive power, the second lens having a negative refractive power and the surface on the image side formed to be the concave surface, the third lens formed in a meniscus shape having a positive refractive power with the convex surface faced to the image side, and the fourth lens having a negative refractive power and the surface on the image side formed to be the concave surface, the imaging apparatus satisfying the conditional expressions (1) to (5).

Therefore, since an entrance pupil position can be set at a position distant from the image surface, the incident angle to the image surface is optimized and it is possible to obtain a compact imaging lens having various aberrations suitably compensated and good optical characteristics and a compact imaging apparatus provided with the imaging lens.

### [Embodiment of Imaging Apparatus]

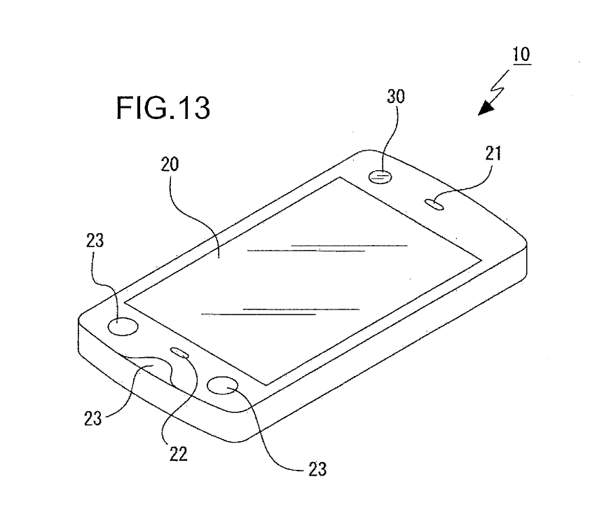

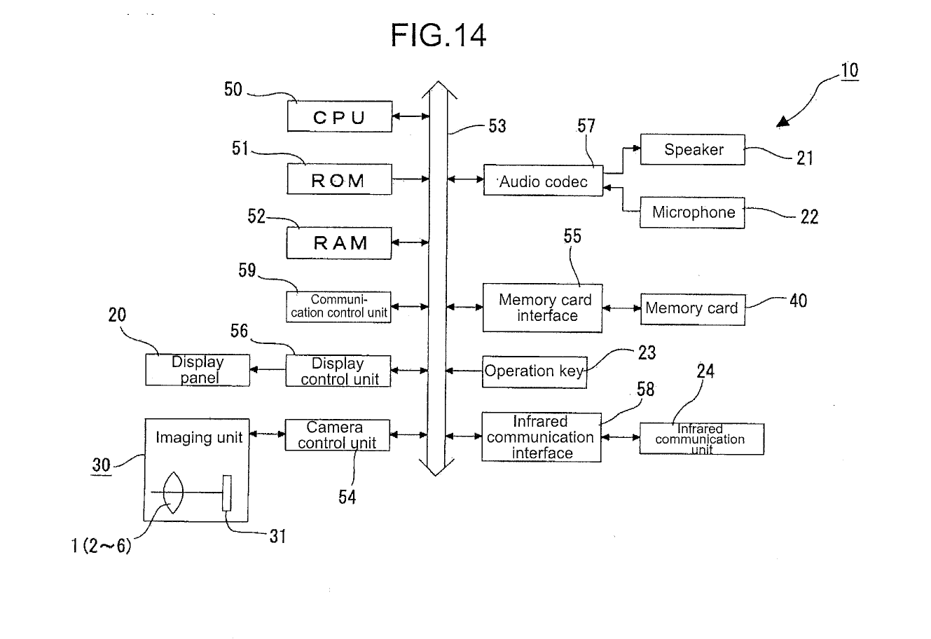

Next, an embodiment in which the imaging apparatus according to an embodiment of the present technology is applied to a mobile phone will be described (see FIGS. 13 and 14).

A display panel 20, a speaker 21, a microphone 22, and operation keys 23, . . . are provided on one surface of a mobile phone 10. The mobile phone 10 incorporates an imaging unit 30 having an imaging lens 1, an imaging lens 2, an imaging lens 3, an imaging lens 4, an imaging lens 5, or an imaging lens 6.

The imaging unit 30 includes not only the imaging lens 1, the imaging lens 2, the imaging lens 3, the imaging lens 4, the imaging lens 5, or the imaging lens 6, but also an imaging element 31 such as charge coupled devices (CCDs) and complementary metal oxide semiconductors (CMOSs).

The mobile phone 10 includes an infrared communication unit 24 for performing infrared communication.

A memory card 40 is inserted into and removed from the mobile phone 10.

The mobile phone 10 includes a central processing unit (CPU) 50. The CPU 50 controls the entire operation of the mobile phone 10. For example, the CPU 50 extracts a control program stored in a read-only memory (ROM) 51 into a random access memory (RAM) 52, and controls the operation of the mobile phone 10 via a bus 53.

A camera control unit 54 controls the imaging unit 30 and includes a function for capturing a still image and a moving image. The camera control unit 54 compresses captured image information into a joint photographic experts group (JPEG) or a moving picture experts group (MPEG), and sends the compressed data to the bus 53.

The image information sent to the bus 53 is temporarily stored in the RAM 52. According to need, the image information is output to a memory card interface 55 and is stored in the memory card 40 by the memory card interface 55, or it is displayed on the display panel 20 via a display controller 56.

During the capturing operation, audio information recorded through the microphone 22, together with the image information, is also stored in the RAM 52 temporarily or stored in the memory card 40 via an audio codec 57. Moreover, simultaneously with image display on the display panel 20, the stored audio information is output via the audio codec 57 from the speaker 21.

The image information and the audio information are output to an infrared communication interface 58 according to need, are output to the external via the infrared communication unit 24 by the infrared communication interface 58, and are transmitted to other apparatuses having an infrared communication unit such as a mobile phone, a personal computer, and a personal digital assistant (PDA). When a moving image or a still image is displayed on the display panel 20 in accordance with the image information stored in the RAM 52 or the memory card 40, a file stored in the RAM 52 or the memory card 40 is decoded or decompressed by the camera control unit 54, and image data obtained by the decoding or decompression is sent via the bus 53 to the display control unit 56.

A communication control unit 59 sends and receives radio waves to and from a base station via an antenna (not shown). In an audio communication mode, the communication control unit 59 processes audio information that has been received and outputs the information via the audio codec 57 to the speaker 21, or receives via the audio codec 57 audio information collected through the microphone 22, processes the information in a predetermined manner, and sends the information.

With any of the imaging lens 1, the imaging lens 2, the imaging lens 3, the imaging lens 4, the imaging lens 5, and the imaging lens 6, the total optical length can be reduced, as described above, and therefore can be incorporated easily in an imaging apparatus, such as the mobile phone 10, desired to have a thin body.

Although the above described embodiments describe an example in which the imaging apparatus is applied to a mobile phone, the imaging apparatus is not limited to the mobile phone and may be widely applied to any of other various digital input/output apparatuses, such as a digital video camera, a digital still camera, a personal computer equipped with a camera, and a personal digital assistant (PDA) equipped with a camera.

### [Others]

In the imaging lens and the imaging apparatus according to an embodiment of the present technology, a lens having substantially no lens power may be disposed, and the lens including such a lens may be disposed in addition to the first lens to the fourth lens. In this case, the imaging lens and the imaging apparatus according to an embodiment of the present technology may be substantially configured by five lenses or more including the lens disposed in addition to the first lens to the fourth lens.

### [Present Technology]

The present technology can be configured as follows.

<1> An imaging lens, including: in order from an object side to an image side, an aperture stop; a first lens formed in a biconvex shape having a positive refractive power; a second lens having a negative refractive power and a surface on the image side formed to be a concave surface; a third lens formed in a meniscus shape having a positive refractive power with a convex surface faced to the image side; and a fourth lens having a negative refractive power and a surface on the image side formed to be a concave surface, the imaging lens satisfying the following conditional expressions (1) to (5),

0≦(R2+R1)/(R2−R1)≦1 (1)

R3≦0 (2)

0.1<D34/f<0.3 (3)

−8≦(R6+R5)/(R6−R5)≦−2 (4)

R7≦0 (5)

where
R1 is a radius of curvature of a surface on the object side in the first lens,
R2 is a radius of curvature of a surface on the image side in the first lens,
R3 is a radius of curvature of a surface on the object side in the second lens,
f is a focal length of an entire lens system,
D34 is an air interval between the third lens and the fourth lens,
R5 is a radius of curvature of a surface on the object side in the third lens,
R6 is a radius of curvature of a surface on the image side in the third lens, and
R7 is a radius of curvature of a surface on the object side in the fourth lens.

<2> The imaging lens according to Item <1>, further satisfying the following conditional expression (6),

0<D34−D23 (6)

where
D23 is an air interval between the second lens and the third lens, and
D34 is an air interval between the third lens and the fourth lens.

<3> The imaging lens according to Item <1> or <2>, in which the first lens, the third lens, and the fourth lens have the same refractive index and Abbe number.

<4> The imaging lens according to Item <3>, in which a refractive index of the second lens is larger than the refractive index of the first lens, the third lens, and the fourth lens.

<5> An imaging apparatus including: an imaging lens; and an imaging element configured to convert an optical image formed by the imaging lens into an electric signal, in which the imaging lens including: in order from an object side to an image side, an aperture stop; a first lens formed in a biconvex shape having a positive refractive power; a second lens having a negative refractive power and a surface on the image side formed to be a concave surface; a third lens formed in a meniscus shape having a positive refractive power with a convex surface faced to the image side; and a fourth lens having a negative refractive power and a surface on the image side formed to be a concave surface, the imaging lens satisfying the following conditional expressions (1) to (5),

0≦(R2+R1)/(R2−R1)≦1 (1)

R3≦0 (2)

0.1<D34/f<0.3 (3)

−8≦(R6+R5)/(R6−R5)≦−2 (4)

R7≦0 (5)

where
R1 is a radius of curvature of a surface on the object side in the first lens,
R2 is a radius of curvature of a surface on the image side in the first lens,
R3 is a radius of curvature of a surface on the object side in the second lens,
f is a focal length of an entire lens system,
D34 is an air interval between the third lens and the fourth lens,
R5 is a radius of curvature of a surface on the object side in the third lens,
R6 is a radius of curvature of a surface on the image side in the third lens, and
R7 is a radius of curvature of a surface on the object side in the fourth lens.

<6> The imaging lens according to any one of Items <1> to <4> or the imaging apparatus according to Item <5>, further including a lens having substantially no lens power.

The shapes and values of relevant elements described in the above embodiments are only examples for embodying the present technology and do not limit the technical scope of the present technology.

The present disclosure contains subject matter related to that disclosed in Japanese Priority Patent Application JP 2011-272381 filed in the Japan Patent Office on Dec. 13, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging lens, comprising: in order from an object side to an image side,
an aperture stop;
a first lens formed in a biconvex shape having a positive refractive power;
a second lens having a negative refractive power and a surface on the image side formed to be a concave surface;
a third lens formed in a meniscus shape having a positive refractive power with a convex surface faced to the image side; and
a fourth lens having a negative refractive power and a surface on the image side formed to be a concave surface, the imaging lens satisfying the following conditional expressions (1) to (5),
0≦(R2+R1)/(R2−R1)≦1 (1)
R3≦0 (2)
0.1<D34/f<0.3 (3)
−8≦(R6+R5)/(R6−R5)≦−2 (4)
R7≦0 (5)
where
R1 is a radius of curvature of a surface on the object side in the first lens,
R2 is a radius of curvature of a surface on the image side in the first lens,
R3 is a radius of curvature of a surface on the object side in the second lens,
f is a focal length of an entire lens system,
D34 is an air interval between the third lens and the fourth lens,
R5 is a radius of curvature of a surface on the object side in the third lens,
R6 is a radius of curvature of a surface on the image side in the third lens, and
R7 is a radius of curvature of a surface on the object side in the fourth lens.

2. The imaging lens according to claim 1, further satisfying the following conditional expression (6),
0<D34−D23 (6)
where
D23 is an air interval between the second lens and the third lens, and
D34 is an air interval between the third lens and the fourth lens.

3. The imaging lens according to claim 1, wherein
the first lens, the third lens, and the fourth lens have the same refractive index and Abbe number.

4. The imaging lens according to claim 3, wherein
a refractive index of the second lens is larger than the refractive index of the first lens, the third lens, and the fourth lens.

5. An imaging apparatus, comprising:
an imaging lens; and
an imaging element configured to convert an optical image formed by the imaging lens into an electric signal, the imaging lens including, in order from an object side to an image side,
an aperture stop,
a first lens formed in a biconvex shape having a positive refractive power,
a second lens having a negative refractive power and a surface on the image side formed to be a concave surface,
a third lens formed in a meniscus shape having a positive refractive power with a convex surface faced to the image side, and
a fourth lens having a negative refractive power and a surface on the image side formed to be a concave surface, the imaging lens satisfying the following conditional expressions (1) to (5),
0≦(R2+R1)/(R2−R1)≦1 (1)
R3≦0 (2)
0.1<D34/f<0.3 (3)
−8≦(R6+R5)/(R6−R5)≦−2 (4)
R7≦0 (5)
where
R1 is a radius of curvature of a surface on the object side in the first lens,
R2 is a radius of curvature of a surface on the image side in the first lens,
R3 is a radius of curvature of a surface on the object side in the second lens,
f is a focal length of an entire lens system,
D34 is an air interval between the third lens and the fourth lens,
R5 is a radius of curvature of a surface on the object side in the third lens,
R6 is a radius of curvature of a surface on the image side in the third lens, and
R7 is a radius of curvature of a surface on the object side in the fourth lens.
